(19) United States
(12) Patent Application Publication
(10) Pub. No.: US 2022/0398832 A1
(43) Pub. Date: Dec. 15, 2022

(54) TRAINING A NEURAL NETWORK FOR ACTION RECOGNITION

(71) Applicant: Sony Group Corporation, Tokyo (JP)

(72) Inventors: Olivier MOLINER, Basingstoke (GB); Sangxia HUANG, Malmö (SE)

(21) Appl. No.: 17/752,614

(22) Filed: May 24, 2022

(30) Foreign Application Priority Data
Jun. 11, 2021 (SE) 2150749-6

(51) Int. Cl. G06V 10/774; G06N 3/04; G06V 10/82; G06V 10/34

(52) U.S. Cl. CPC G06V 10/7747; G06N 3/0454; G06V 10/82; G06V 10/34; G06V 40/23

(57) ABSTRACT

A system for training a neural network for action recognition based on unlabeled action sequences includes a first neural network (NN1) and a second neural network (NN2). A first updating module is arranged to update parameters of NN1 to minimize a difference between representation data generated by NN1 and representation data generated by NN2. A second updating module is arranged to update parameters of NN2 as a function of the parameters of NN1. An augmentation module includes first and second sub-modules and is configured to include augmented versions of incoming action sequences in first and second input data. The first and second sub-modules are configured to apply at least partly different augmentation to the incoming action sequences. After NN1 and NN2 have been operated on one or more instances of the first and second input data, NN1 comprises a parameter definition of a pre-trained neural network.

### CROSS REFERENCE TO RELATED APPLICATIONS

The present application claims priority to Swedish Patent Application No. 2150749-6, filed Jun. 11, 2021, the content of which is incorporated herein by reference in its entirety.

### Technical Field

The present disclosure relates generally to training of neural networks and, in particular, to such training for action recognition in time-sequences of data samples that represent objects performing various actions.

### Background Art

Action recognition, classification and understanding in videos or other time-resolved reproductions of moving subjects (humans, animals, etc.) form a significant research domain in computer vision. Action recognition, also known as activity recognition, has many applications given the abundance of available moving visual media in today's society, including intelligent search and retrieval, surveillance, sports events analytics, health monitoring, human-computer interaction, etc. At the same time, action recognition is considered one of the most challenging tasks of computer vision.

Neural networks have shown great promise for use in systems for action recognition. Neural networks may be trained by use of recordings that are associated with accurate action annotations (labels). Conventionally, the process of annotating recordings is performed manually by experts in the field and is both time-consuming and expensive.

Self-supervised learning (SSL) aims to learn feature representations from large amounts of unlabeled data. It has been proposed to use self-supervised training to help supervised training, by pre-training a network by use of unlabeled data and then fine-tuning the pre-trained network by use of a small amount of labeled data. Such an approach applied on individual images is described in the article “Bootstrap your own latent—a new approach to self-supervised learning”, by Grill et al, arXiv:2006.07733v3 [cs.LG] 10 Sep. 2020. The pre-training relies on two neural networks that interact and learn from each other. The pre-training uses augmented views generated from input images by a single augmentation pipeline. From an augmented view of an image, a first network is trained to predict the representation generated by the second network for another augmented view of the same image. Concurrently, the second network is updated with a slow-moving average of the first network.

### BRIEF SUMMARY

It is an objective to at least partly overcome one or more limitations of the prior art.

Another objective is to improve action recognition in input data by neural networks.

A further objective is to reduce the amount of labelled input data needed to train a neural network to perform action recognition at a given accuracy.

One or more of these objectives, as well as further objectives that may appear from the description below, are at least partly achieved by a system, a method, and a computer-readable medium according to the independent claims, embodiments thereof being defined by the dependent claims.

Still other objectives, as well as features, aspects and technical effects will appear from the following detailed description, from the attached claims as well as from the drawings.

### BRIEF DESCRIPTION OF DRAWINGS

FIG. 1A shows an example of a time sequence of images and a corresponding time sequence of skeleton data extracted from the images, and FIG. 1B shows skeleton data representing an object in an image.

FIG. 2 shows an example of using a trained neural network for action recognition.

FIG. 3 is a functional block diagram of an example system for pre-training a neural network.

FIG. 4 is a functional block diagram of example augmentation sub-modules in the system of FIG. 3.

FIG. 5 is a functional block diagram of an example pre-training structure in the system of FIG. 3.

FIG. 6 is a flow chart of an example method for use in training of a neural network.

FIGS. 7A-7E depict example augmentation operations performed by an augmentation module.

FIG. 8 is a functional block diagram of a sub-system for fine-tuning of a pre-trained neural network.

FIG. 9 is a functional block diagram of a sub-system for knowledge distillation by use of a fine-tuned neural network.

FIG. 10 is a block diagram of a machine that may implement methods disclosed herein.

### DETAILED DESCRIPTION OF EXAMPLE EMBODIMENTS

Embodiments will now be described more fully hereinafter with reference to the accompanying drawings, in which some, but not all, embodiments are shown. Indeed, the subject of the present disclosure may be embodied in many different forms and should not be construed as limited to the embodiments set forth herein; rather, these embodiments are provided so that this disclosure may satisfy applicable legal requirements.

Also, it will be understood that, where possible, any of the advantages, features, functions, devices, and/or operational aspects of any of the embodiments described and/or contemplated herein may be included in any of the other embodiments described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more”, even though the phrase “one or more” or “at least one” is also used herein. As used herein, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments. The term “compute”, and derivatives thereof, is used in its conventional meaning and may be seen to involve performing a calculation involving one or more mathematical operations to produce a result, for example by use of a computer.

As used herein, the terms “multiple”, “plural” and “plurality” are intended to imply provision of two or more elements, whereas the term a “set” of elements is intended to imply a provision of one or more elements. The term “and/or” includes any and all combinations of one or more of the associated listed elements.

It will furthermore be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing the scope of the present disclosure.

Well-known functions or constructions may not be described in detail for brevity and/or clarity. Unless otherwise defined, all terms (including technical and scientific terms) used herein have the same meaning as commonly understood by one of ordinary skill in the art to which this disclosure belongs.

Like numbers refer to like elements throughout.

Before describing embodiments in more detail, a few definitions will be given.

As used herein, “keypoint” has its conventional meaning in the field of computer vision and is also known as an interest point. A keypoint is a spatial location or point in an image that define what is interesting or what stand out in the image and may be defined to be invariant to image rotation, shrinkage, translation, distortion, etc. More generally, a keypoint may be denoted a “reference point” on an object to be detected in the image, with the reference point having a predefined placement on the object. Keypoints may be defined for a specific type of object, for example a human or animal body, a part of the human or animal body, or an inanimate object with a known structure or configuration. In the example of a human or animal body, keypoints may identify one or more joints and/or extremities. Keypoints may be detected by use of any existing feature detection algorithm(s), for example image processing techniques that are operable to detect one or more of edges, corners, blobs, ridges, etc. in digital images. Non-limiting examples of feature detection algorithms comprise SIFT (Scale-Invariant Feature Transform), SURF (Speeded Up Robust Feature), FAST (Features from Accelerated Segment Test), SUSAN (Smallest Univalue Segment Assimilating Nucleus), Harris affine region detector, and ORB (Oriented FAST and Rotated BRIEF). Further information about conventional keypoint detectors is found in the article “Local invariant feature detectors: a survey”, by Tuytelaars et al, published in Found. Trends. Comput. Graph. Vis. 3(3), 177-280 (2007). Further examples of feature detection algorithms are found in the articles “Simple Baselines for Human Pose Estimation and Tracking”, by Xiao et al, published at ECCV 2018, and “Deep High-Resolution Representation Learning for Human Pose Estimation”, by Sun et al, published at CVPR 2019. Correspondingly, objects may be detected in images by use of any existing object detection algorithm(s). Non-limiting examples include various machine learning-based approaches or deep learning-based approaches, such as Viola—Jones object detection framework, SIFT, HOG (Histogram of Oriented Gradients), Region Proposals (RCNN, Fast-RCNN, Faster-RCNN), SSD (Single Shot MultiBox Detector), You Only Look Once (YOLO, YOLO9000, YOLOv3), and RefineDet (Single-Shot Refinement Neural Network for Object Detection).

As used herein, “pose” defines the posture of an object and comprises a collection of positions which may represent keypoints. The positions may be two-dimensional (2D) positions, for example in an image coordinate system, resulting in a 2D pose, or three-dimensional (3D) positions, for example in a scene coordinate system, resulting in a 3D pose. A 3D pose may be generated based on two or more images taken from different viewing angles, or by an imaging device capable of depth-sensing, for example as implemented by Microsoft Kinect™. A pose for a human or animal object is also referred to as a “skeleton” herein.

As used herein, “action sequence” refers to a time sequence of data samples that depict an object while the object performs an activity. The activity may or may not correspond to one or more actions among a group of predefined actions. If the activity corresponds to one or more predefined actions, the action sequence may be associated with one or more labels or tags indicative of the predefined action(s). Such an action sequence is “labeled” or “annotated”. An action sequence that is not associated with a label or tag is “unlabeled” or “non-annotated”. The action sequence may be a time sequence of images, or a time sequence of poses. When based on poses, the action sequence may be seen to comprise a time sequence of object representations, with each object representation comprising locations of predefined features on the object.

As used herein, “neural network” refers to a computational learning system that uses a network of functions to understand and translate a data input of one form into a desired output, usually in another form. The neural network comprises a plurality of interconnected layers of neurons. A neuron is an algorithm that receives inputs and aggregates them to produce an output, for example by applying a respective weight to the inputs, summing the weighted inputs and passing the sum through a non-linear function known as an activation function.

Embodiments are related to training of neural networks for action recognition, in particular with limited access to labeled data. Some embodiments relate to techniques of training a neural network to generate labeled action sequences from unlabeled action sequences. Some embodiments belong the field of self-supervised learning (SSL) and involves data augmentation of the unlabeled action sequences as a technique of priming a neural network with desirable invariances. By training the neural network to ignore variances among data samples that are irrelevant for action recognition, the trained neural network will be capable of creating meaningful representations of the unlabeled action sequences. Some embodiments relate to techniques for configuring the data augmentation to improve the performance of the trained neural network in terms of its representations of the unlabeled action sequences. Some embodiments relate to techniques for further improving the performance of such a trained neural network.

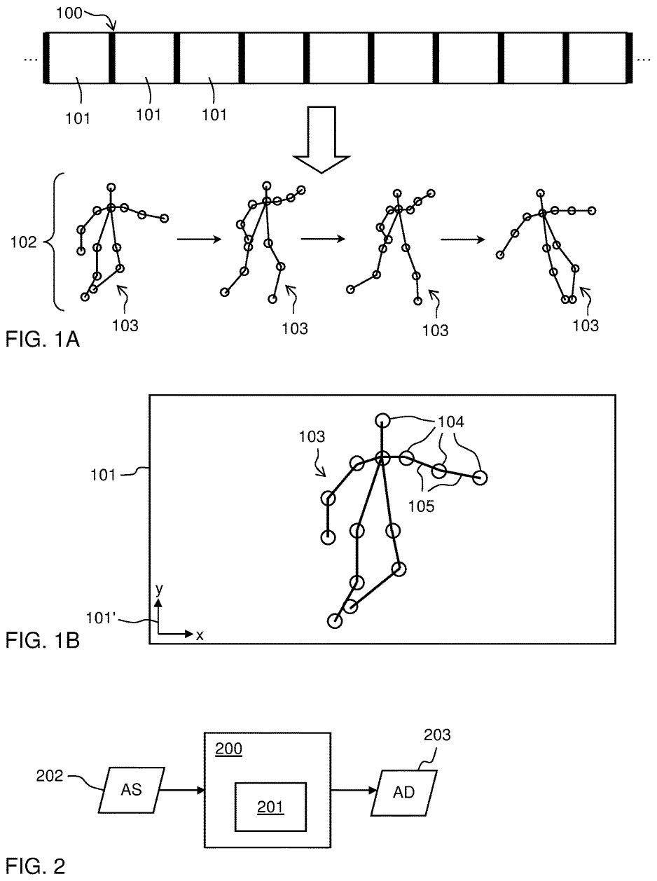

FIG. 1A schematically shows a sequence of images 101. The images 101 correspond to consecutive time points and form an image sequence 100. The images 101 have been captured by an imaging device (not shown) and depict an object (not shown) that performs an activity. The object may be any type of object, animate or inanimate. In the following description, it is assumed that the object is a human or animal. As is well-known in the art, the image sequence 100 may be converted into a corresponding time sequence 102 of keypoint groups 103, as indicated in FIG. 1A. This time sequence 102 is also referred to as a “skeleton sequence” in the following. Each keypoint group 103, also denoted “skeleton” herein, comprises a plurality of keypoints 104 (FIG. 1B) that have a predefined placement on the object. FIG. 1B schematically depicts a skeleton 103 as identified in an image 101. For illustrative purposes, the keypoints 104 have been connected by links 105 to represent an approximate skeleton structure of the object. The respective keypoint 104 in a skeleton 103 is represented by a unique identifier (keypoint identifier), for example a number, and is associated with a respective location in a predefined coordinate system, for example a 2D coordinate system 101′ of the image 101. Skeletons of the same object at different time points may be associated into skeleton sequences 102 in any conventional way, for example by spatial proximity, appearance, etc. The skeleton sequence 102 in FIG. 1A may, for example, be seen to represent an individual that performs the action of shooting a football.

Action recognition involves processing action sequences to determine one or more actions performed the object in the action sequences. It is a complex task subject to active research. Neural networks are well-suited for this task if properly trained. FIG. 2 shows an example installation of a trained neural network 201 for action recognition in an action recognition system 200. The system 200 operates the neural network 201 on an unlabeled action sequence, AS, 202 to generate action data, AD, 203, which is indicative of the action(s) performed by the subject represented by the AS 202. It is realized that the neural network 201 has been trained to recognize a predefined set of actions, also denoted “action classes” herein. The action classes are dependent on the intended deployment of the system 201. Non-limiting examples include running, jumping, throwing, diving, skiing, kicking, shooting, drinking, sitting, cycling, rowing, swimming, etc.

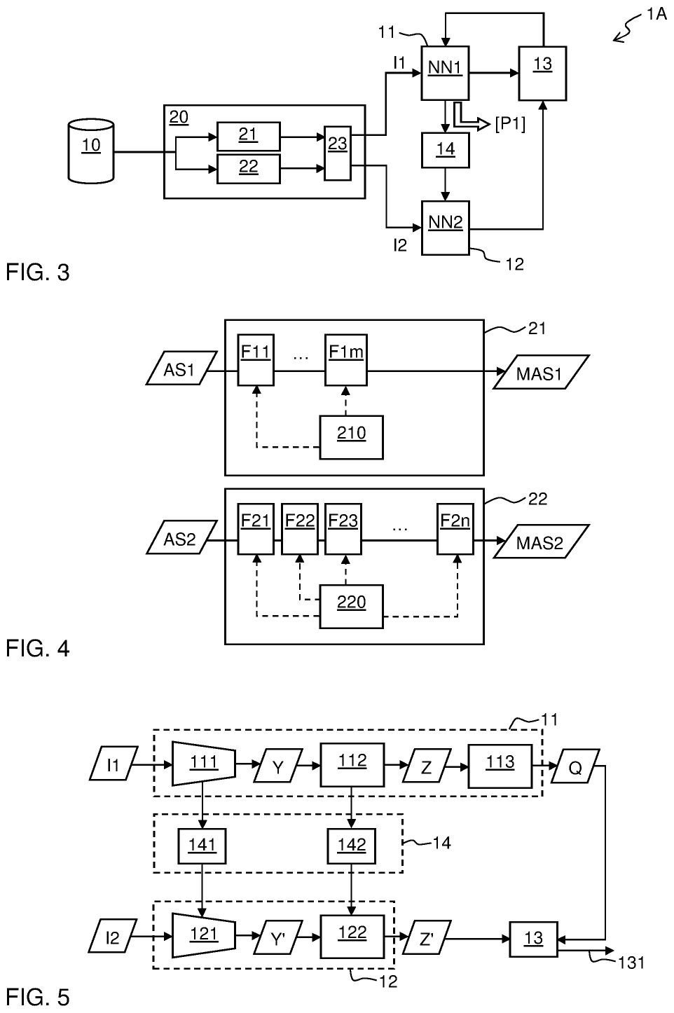

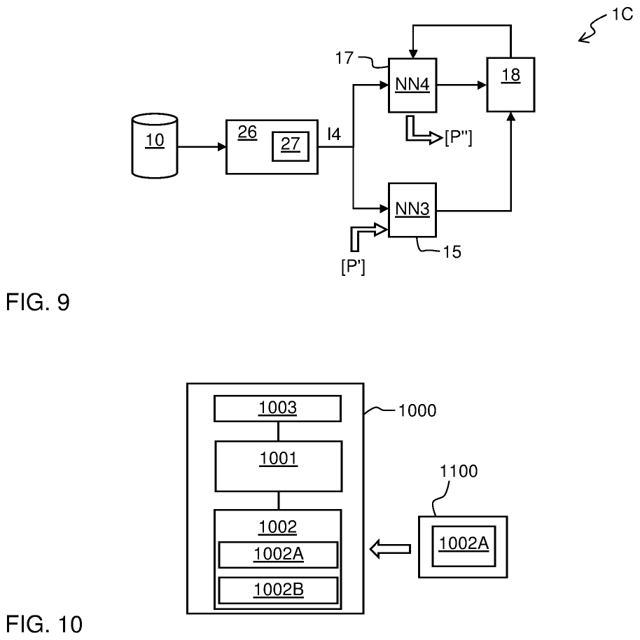

It is currently believed that the use of skeleton data will improve the performance of action recognition by neural networks. The conversion from images to skeletons may be advantageous as it reduces the amount of data that has to be processed for action recognition. This enables use of light-weight and robust action recognition algorithms. Training such algorithms in a fully-supervised manner requires large datasets of skeleton data with accurate action annotation. However, skeleton-based training data is scarce and generating the required datasets is a time-consuming and expensive process requiring domain experts. Embodiments to be described in the following, with reference to FIGS. 3-7, address how to leverage unlabeled data to pre-train a neural network to learn feature representations of sufficient quality and relevance to be transferred to a downstream task of action classification, as described with reference to FIGS. 9-10, by use of a small dataset of labeled data.

While the following description may refer to the use of action sequences in the form of skeleton sequences, it is equally applicable to other types of action sequences, for example comprising a respective time sequence of digital images. Similarly, although the object may be presented as a human or animal, it may be an inanimate object.

FIG. 3 is a block diagram of an example pre-training system 1A, which is configured to pre-train a neural network based on unlabeled action sequences stored in a database 10. The action sequences depict one or more objects performing one or more activities. These activities may include actions to be recognized by the neural network and/or other actions. As is well-known in the art, training of a neural network involves determining values of control parameters of the neural network to generate desired output data based on input data. Such control parameters may comprise weights and/or biases within the neural network. The system 1A comprises a first neural network (NN1) 11, which is configured to operate on first input data I1, and a second neural network (NN2) 12, which is configured to operate on second input data I2. A first updating module 13 is arranged to receive first representation data from NN1 and second representation data from NN2. The first and second representation data may be in any format and are generated to represent I1 and I2, respectively. The first updating module 13 is configured to update control parameters of NN1 to minimize a difference between the first representation data and the second representation data. The module 13 may implement any conventional updating function, for example backpropagation, by use of any suitable classification loss function, including but not limited to cross-entropy loss, log loss, hinge loss, square loss, or variants or derivatives thereof. The backpropagation may include any suitable stochastic or non-stochastic optimization algorithm, including but not limited to gradient descent, nonlinear conjugate gradient, limited-memory BFGS, Levenberg-Marquardt algorithm, etc. A second updating module 14 is configured to update control parameters of NN2 as a function of the control parameters of NN1. In some embodiments, the second updating module 14 updates NN2 whenever the first updating module 13 has updated NN1. By the second updating module 14, NN2 is “bootstrapped” to NN1. In the pre-training system 1A, NN1 may be seen as an online neural network, and NN2 may be seen as a target network. In some embodiments, NN1 and NN2 share the same network architecture, at least in part, so that there is one-to-one correspondence between the control parameters of NN2 that are updated by module 14 and control parameters in NN1. In some embodiments, the module 14 may be configured to replace the control parameters in NN2 by the control parameters in NN1. In some embodiments, to stabilize the bootstrapping, module 14 generates the value of the respective control parameter in NN2 based on a temporal aggregation of values of the corresponding control parameter in NN1. In one example, the temporal aggregation comprises a moving average, for example an exponential moving average.

The system 1A in FIG. 3 is configured to operate NN1 and NN2 on one or more instances or “batches” of I1 and 12 generated by the augmentation module 20 to perform a pre-training operation. When the pre-training operation of the system 1A is completed, values of at least a subset of the control parameters of NN1, represented as [P1] in FIG. 3, may be obtained to represent a pre-trained neural network.

The system 1A in FIG. 3 further comprises an augmentation module 20, which is configured to operate on action sequences retrieved from the database 10 to generate I1 and I2. Data augmentation is a well-known concept in the field of neural networks and involves imparting selected modifications to the input data of a neural network during training to improve the ability of the neural network, when trained, to handle variations in the input data. The augmentation module 20 in FIG. 3 is configured to operate on pairs of action sequences to generate pairs of augmented action sequences and include the respective pair of augmented action sequences in both I1 and I2. In the illustrated example, the augmentation module 20 comprises a first sub-module 21 which is configured to generate a first augmented action sequence based on a first action sequence in each pair, and second sub-module 22 which is configured to generate a second augmented action sequence based on a second action sequence in each pair. An output sub-module 23 is arranged to include the first and second augmented action sequences in I1 and I2. After significant experimentation, the present Applicant has surprisingly found that the performance of the pre-trained neural network may be improved by configuring the first and second sub-modules 21, 22 to differ from each other in terms of the augmentation they apply to the incoming action sequences. Specifically, one sub-module is operable to impart more augmentation than the other sub-module, and possibly significantly more augmentation. In this context, “more augmentation” implies that it is more difficult to match the second augmented action sequence to its underlying action sequence than to match the first augmented action sequence to its underlying action sequence. Accordingly, in the following examples, sub-module 21 is operable to perform a “conservative augmentation”, and sub-module 22 is operable to perform an “aggressive augmentation”.

FIG. 4 is a block diagram of sub-modules 21 and 22 in accordance with an example. Sub-module 21 is operable to apply a set of first augmentation functions on an incoming action sequence, AS1, to generate an augmented or modified action sequence, MAS 1. The first augmentation functions are represented as F11, . . . , F1m in FIG. 4. Sub-module 22 is operable to apply a set of second augmentation functions on an incoming action sequence, AS2, to generate an augmented or modified action sequence, MAS2. The second augmentation functions are represented as F21, F22, F23, . . . , F2n in FIG. 4. Generally, n≥1 and m≥1. A control unit 210 of sub-module 21 operates the first augmentation function(s) on AS1 to generate MAS2, and a control unit 220 of sub-module 22 operates the second augmentation function(s) on AS2 to generate MAS2. In some embodiments, the respective control unit 210, 220 is configured to perform a randomized control of the available augmentation functions. For example, the available augmentation functions may be randomly activated to operate on an incoming action sequence and/or one or more control parameters of the respective augmentation function may be set to a random value within predefined limits. Thus, each of the sub-modules 21, 22 may be seen to define an augmentation pipeline which is deterministically or randomly controlled to apply available augmentation functions on incoming action sequences to generate augmented action sequences.

In accordance with embodiments, the sub-modules 21, 22 differ by at least one augmentation function. In one example, consistent with the above-mentioned aggressive-conservative configuration, sub-module 22 comprises the augmentation function(s) of sub-module 21, or a subset thereof, and one or more additional augmentation functions. In another example, which also may be consistent with the aggressive-conservative configuration, the augmentation function(s) in sub-module 22 differ from the augmentation function(s) in sub-module 21.

Reverting to FIG. 3, it is to be noted that MAS 1, MAS2 may be included in I1, I2 so as to be provided concurrently to NN1 and NN2. Thereby, NN1 and NN2 will jointly and concurrently operate on the pair of augmented action sequences, (MAS1, MAS2), and generate corresponding first and second representation data for processing by the first updating module 13. Further, as noted above, MAS1 and MAS2 are included in both I1 and I2, which means that NN1 will operate on MAS1 while NN2 operates on MAS2, and NN1 operates on MAS2 while NN2 operates on MAS1. In some embodiments, MAS1 and MAS2 are included to be consecutive in I1 and I2, but in opposite orders. Thereby, MAS1 and MAS2 will form a first pair (MAS1, MAS2) and a second pair (MAS2, MAS1) which are processed in succession by NN1 and NN2. The first updating module 13 may be configured to operate its updating function to jointly minimize the differences between the first representation data and the second representation data that are generated for the first and second pairs, for example by including the differences in a loss function.

In some embodiments, the action sequences AS1, AS2 in at least some of the pairs are identical. For example, the augmentation module 20 may retrieve a single action sequence from the database 10 and duplicate it to form AS1, AS2. Alternatively, each action sequence may be stored in two copies in the database 10 for retrieval by the augmentation module 20. This type of action sequences is referred to as “duplicate AS” in the following.

In some embodiments, the action sequences AS1, AS2 in at least some of the pairs are taken from two different viewing angles onto the object while it performs an activity, referred to a “multiview AS” in the following. Thus, AS1 and AS2 may be recorded at the same time to depict the object from two different directions. For example, the multiview AS may originate from two imaging devices in different positions in relation to the object. The use of multi-view AS in pre-training is currently believed to improve performance, for example by allowing the neural network to learn representations that are robust to changes of viewpoint and different camera properties. It may be noted that I1, I2 may be generated to include both duplicate AS and multiview AS, as well as other types of action sequences.

FIG. 5 shows an implementation example of the pre-training part of the system 1A in FIG. 3. In the illustrated example, the first neural network 11 (NN1) comprises an encoder 111, which is configured to receive the input data I1 and generate an intermediate representation Y of an incoming action sequence. The encoder 111 may be of any conventional type suitable for action recognition including but not limited to a recurrent neural network (RNN) or a convolutional neural network (CNN). In a specific example, the encoder is a Spatial-Temporal Graph Convolutional Network (ST-GCN). A projector 112 is arranged to receive and project the intermediate representation Y to a smaller space, resulting in projection data Z. The projector 112 may be of any conventional type. In one non-limiting example the projector 112 is or comprises a multi-layer perceptron (MLP). A predictor 113 is configured to receive the projection data Z and generate a prediction Q, which is output from the first neural network 11 and thus forms the above-mentioned first representation data. The predictor 113 may use the same architecture as the projector 112. The second neural network 12 (NN2) comprises an encoder 121, which is configured to receive the input data 12 and generate an intermediate representation Y′ of an incoming action sequence. The encoder 112 may or may not have the same architecture as the encoder 111. A projector 122 is arranged to receive and project the intermediate representation Y′ to a smaller space, resulting in projection data Z′. The projector 122 may be of any conventional type and may or may not have the same architecture as the projector 112. The projection data Z′ is output from the second neural network 12 and thus forms the above-mentioned second representation data. The purpose of including the projectors 112, 122 and the predictor 113 is to reduce the amount of data and facilitate processing, as is well-known to the skilled person. In variants, one or more of the modules 112, 122, 113 are omitted.

The first updating module 13 is configured to receive Q and Z′ and, based on Q and Z′ for a number of incoming action sequences, compute and update the values of control parameters of the first neural network 11, as indicated by an arrow 131. It is to be noted that the first updating module 13 does not update the control parameters of the second neural network 12.

In the illustrated example, the second updating module 14 comprises a first sub-module 141, which is configured to update control parameters of encoder 121 based on control parameters of encoder 111, and a second sub-module 142, which is configured to update control parameters of projector 122 based on control parameters of projector 112. The first and second sub-modules 141, 142 may use the same or different functions to update the control parameters.

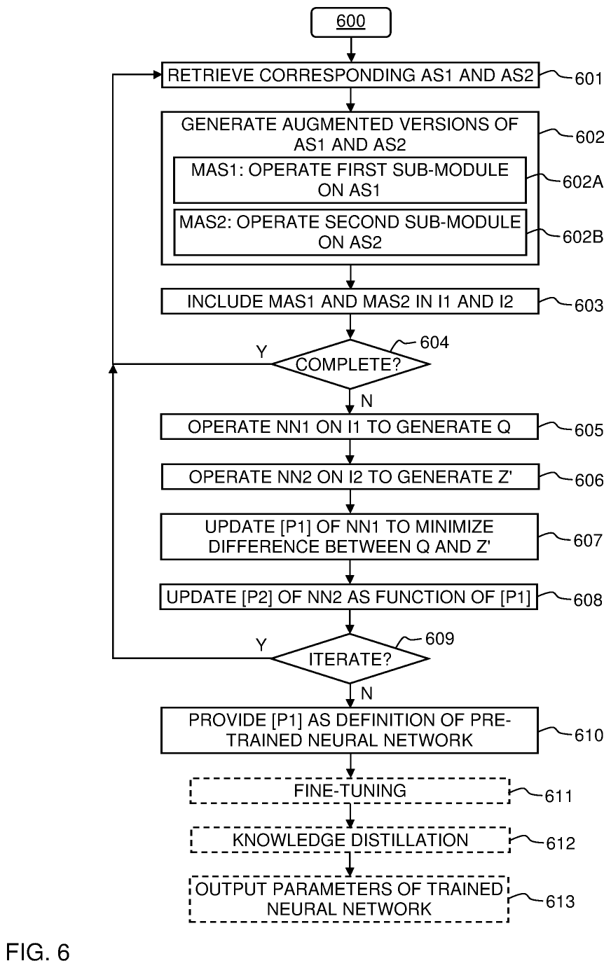

FIG. 6 is a flow chart of an example method of operating the pre-training system 1A shown in FIGS. 3-5. The method 600 comprises a first repeating sequence of steps 601-604, which generates a respective instance of I1, I2. Each such instance comprises a batch of pairs of augmented action sequences. Steps 601-604 are performed by the augmentation module 20. The method 600 comprises a second repeating sequence of steps, which optimizes the control parameters of the NN1 based on different instances of I1, I2 generated by the first repeating sequence of steps 601-604. The optimization corresponds to steps 605-608 and is performed collectively by NN1, NN2 and the updating modules 13, 14. When the optimization is completed, step 610 provides at least a subset of the control parameter values, [P1], as a definition of a pre-trained neural network.

In the illustrated example, step 601 comprises retrieving AS1 and AS2 from the database 10. As noted above, step 601 may perform duplicate AS or multiview AS to retrieve AS1, AS2. Step 602 comprises generating augmented versions of AS1 and AS2. Step 602 may be seen to comprise sub-step 602A, in which MAS1 is generated by operating the first sub-module 21 on AS1, and sub-step 602B, in which MAS2 is generated by operating the second sub-module 22 on AS2. Step 603 comprises including MAS1 and MAS2 in I1 and I2. Step 603 may also comprise a normalization processing of MAS1 and MAS2 before they are included in I1 and I2. For example, the normalization processing may comprise rotating the poses to face in a predetermined direction, transforming the poses to be centered at the origin, etc. Step 603 may be performed by the output sub-module 23. As understood from the foregoing, MAS1 and MAS2 may be included in I1 to be processed concurrently with MAS2 and MAS1, respectively, in 12. Steps 601-603 are repeated, by step 604, a predefined number of times, to include a predefined number of pairs of augmented action sequences in the input data I1, I2.

The resulting input data I1, I2 is then processed in steps 605-608. Step 605 comprises operating NN1 on I1 to generate the first representation data Q (FIG. 5). Step 606 comprises operating NN2 on I2 to generate the second representation data Z′ (FIG. 5). Step 607 comprises updating the control parameter values [P1] of NN1 to minimize the difference between Q and Z′. Step 608 comprises updating the control parameter values [P2] of NN2 as a function of [P1]. It is to be understood that FIG. 6 is a general overview and should not be interpreted to restrict the method 400 to any particular order of processing. In the example of FIG. 6, the generation of I1, I2 by steps 601-604 is performed to completion before steps 605-608 are initiated. In an alternative, steps 605-608 are performed in synchronization with steps 601-604, so that step 605-608 are operated on each pair of augmented action sequences as they are generated by steps 601-604. In a non-limiting example, steps 605-608 may be implemented to concurrently generate Q and Z′ for each incoming pair of action sequences to NN1 and NN2, compute a loss for each incoming pair as function of Q and Z′, aggregate the loss for pairs of action sequences in I1, I2, compute a total loss gradient with respect to the control parameters of NN1 based on the aggregated loss, and operate an optimizer on the control parameters and the total loss gradient to determine updated control parameter values of NN1.

Irrespective of implementation, when all action sequences in I1, I2 have been processed and [P1] and [P2] have been calculated, step 609 may return the method 600 to step 601 to generate a new batch of I1, I2. Each execution of steps 601 through step 608 may be denoted an optimization step. Step 609 may be arranged to initiate a predefined number of optimization steps. Alternatively, step 609 may be arranged to initiate optimization steps until a convergence criterion is fulfilled.

Reverting to FIG. 4, the augmentation functions included in the first and second sub-modules 21, 22 may implement one or more of resampling, low-pass filtering, noise enhancement, spatial distortion, keypoint removal, mirroring, temporal cropping, and start modification.

An augmentation function for resampling (“resampling function”) is operable to change the time distance between the skeletons in an action sequence, resulting in an increase or decrease in the speed of the action sequence. The resampling function may operate to increase/decrease the speed of one or more subsets of the action sequence. It is conceivable that different subsets of the action sequence are subjected to different resampling. The resampling function may be included to train the neural network to be robust to variations in speed between action sequences.

An augmentation function for low-pass filtering (“LP function”) is operable to perform a temporal smoothing of the time sequence of skeletons in an action sequence (cf. 102 in FIG. 1A). The LP function may be operated on a specific subset of keypoints or all keypoints of the skeleton. The temporal smoothing is performed by operating any suitable low-pass filter on a time sequence of locations of the same keypoint in the action sequence, for example by convolution of a filter (“convolution mask”). The LP function may be included to train the neural network to be robust to variations in object movement when performing an activity.

An augmentation function for noise enhancement (“noise function”) is operable to introduce noise to the keypoint locations in the action sequence. The noise may be statistical noise of any suitable distribution, including but not limited to Gaussian noise. The noise function may be operated on a specific subset of keypoints or all keypoints of the skeleton. The LP function may be included to train the neural network to be robust to noise.

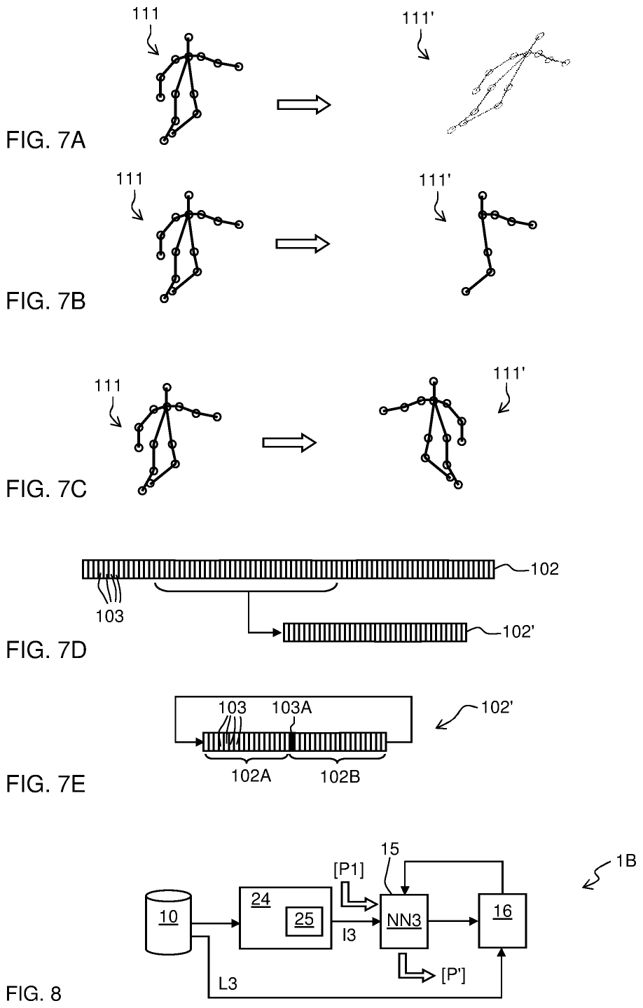

An augmentation function for spatial distortion (“distortion function”) is operable to distort one or more skeletons in an action sequence in a selected direction. The spatial distortion may comprise non-uniform scaling and/or shearing. As used herein, shearing refers to a linear transformation that slants the shape of an object in a given direction, for example by applying a shear transformation matrix to a respective skeleton in the action sequence. An example of a spatial distortion of a skeleton 111 is shown in FIG. 7A, resulting in an augmented skeleton 111′. The distortion function may be operated on a specific subset of keypoints or all keypoints of the skeleton. The distortion function may be included to train the neural network to be robust to different postures of objects when performing an activity.

An augmentation function for keypoint removal (“removal function”) is operable to hide a subset of the keypoints of the skeletons in the action sequence. The respective keypoint is hidden by removal of its location in the definition of the action sequence. The removal function may operate on individual keypoints or a group of keypoints. One such group may be defined in relation to a geometric plane with a predefined arrangement through the object. In one example, the geometric plane is a vertical symmetry plane of the object, and all keypoints on the left or right side of the plane are removed. An example of left-sided keypoint removal in a skeleton 111 is shown in FIG. 7B, resulting in an augmented skeleton 111′. In another example, all keypoints above or below a horizontal plane through the middle of the object are removed. The removal function may be applied to all skeletons in an action sequence, or a subset thereof. The removal function may be included to train the neural network to be robust to dropout of keypoints, for example as a result of occlusion.

An augmentation function for mirroring (“mirror function”) is operable to flip the object through a predefined geometric plane. Each keypoint is thereby repositioned relative to the geometric plane, ending up an equal distance away, but on the opposite side. An example of a mirroring of a skeleton 111 through a vertical mirror plane is shown in FIG. 7C, resulting in an augmented skeleton 111′. The mirror function may be applied to all skeletons in an action sequence. The removal function may be included to train the neural network to be robust to actions performed on different sides of the object, for example as a result of left- or right-handedness.

An augmentation function for temporal cropping (“cropping function”) is operable to extract a temporally coherent subset of the skeletons in an action sequence. An example is shown in FIG. 7D, in which a cropping function operates on an action sequence 102, which comprises a time sequence of skeletons 103, to extract a sub-sequence 102′ of skeletons. The cropping function may be included to train the neural network to be robust to incomplete action sequences.

An augmentation function for start modification (“rearrangement function”) is operable to select a skeleton in the action sequence and rearrange the action sequence with the selected skeleton as starting point. The rearrangement function thereby results in a temporal shift of the action sequence. An example of a rearrangement function is shown in FIG. 7E, in which a selected skeleton 103A separates the action sequence into a leading sub-sequence 102A and a trailing sub-sequence 102B that starts from the selected skeleton 103A. The augmented action sequence 102′ is formed by concatenating the leading sub-sequence 102A after the trailing sub-sequence 102B, so as to loop the action sequence as shown by an arrow. The rearrangement function may optionally operate on the coherent subset extracted by the above-mentioned cropping function (FIG. 7D). The rearrangement function may be included to train the neural network to be robust to incomplete action sequences. In real-world applications, action recognition algorithms are typically applied on overlapping temporal windows, which means that an action of interest may have already started, or may start or end within a window. By the rearrangement function, the neural network may be trained to be robust to such temporal windows.

As noted above, an augmentation function may be controlled based on randomized control parameter value(s). The control parameter value(s) may thereby be changed for each action sequence to be processed. The resampling function may, for example, resample the respective action sequence to a random time interval. The LP function may, for example, operate the low-pass filter on a random subset of keypoints and/or randomly define the low-pass filter. The noise function may, for example, add noise to a random subset of keypoints. The distortion function may, for example, distort a random subset of keypoints and/or randomly define the distortion to be applied in terms of selected direction and/or type of distortion. The removal function may, for example, remove a random subset of keypoints and/or randomly select geometric plane.

The mirror function may, for example, randomly select mirror plane. The cropping function may, for example, randomly select the coherent subset to be extracted. The rearrangement function may, for example, randomly select the skeleton to be used as starting point.

In the above-mentioned aggressive-conservative configuration, the first sub-module 21 may comprise one or more augmentation functions designated as “conservative”. In some embodiments, at least one of the resampling function, the noise function, or the LP function is a conservative function. One or more of the other augmentation functions may be designated as “aggressive” and may be included in the second sub-module 22, which may or may not also include the conservative function(s). Aggressive functions are not included in the first sub-module 21. In some embodiments, an augmentation function may be switched from basic to aggressive by the use of control parameters. For example, a removal function that removes one or a few keypoints may be designated as conservative, whereas a removal function that removes larger groups of keypoints may be designated as aggressive. In this way all of the above examples of augmentation functions may be implemented as a conservative or aggressive function.

Although augmentation functions have been exemplified with reference to skeleton sequences in the foregoing, the skilled person understands that corresponding augmentation functions may be defined to operate on image sequences (cf. 100 in FIG. 1A), albeit at the expense of an increased complexity. Also, image sequences may be augmented by conventional functions, such as blurring, color jittering, solarization, etc.

Reverting to the flow chart of FIG. 6, the definition of the pre-trained neural network, in the form of the control parameter values [P1], may be further processed in a supervised fine-tuning step 611 to generate a trained neural network for specialized action recognition. Thus, while the pre-training is performed in an action-agnostic way, to learn general representations via unsupervised pre-training, the fine-tuning is performed to adapt the general representations for specific actions via supervised fine-tuning. FIG. 8 is a block diagram of an example system 1B for fine-tuning. The fine-tuning system 1B is configured to train a neural network based on a small set of labeled action sequences stored in a database 10. The labeled action sequences depict one or more objects performing one or more predefined actions. Each such action sequence is associated with an activity label for each predefined action performed by the object in the action sequence. By the pre-training, it is sufficient to use a small set of labeled data to train the neural network to be operable for robust and accurate action recognition. The system 1B comprises a third neural network (NN3) 15 which defines an action recognition model. The network architecture of NN3 is at least partly the same as in NN1 (FIG. 3), so that the control parameter values [P1] may be applied as starting values when NN3 is initialized for training. For example, with reference to FIG. 5, NN3 may comprise an encoder that is similar or identical to the encoder 111 in NN1. An updating module 16 is arranged to receive representation data from NN3 and corresponding activity label data L3. The updating module 16 is configured, in conventional manner, to update control parameters of NN3 to minimize a difference between the representation data and the activity label data L3. When the training is completed, the trained NN3 is defined by its control parameter values, [P′]. As indicated in FIG. 8, the system 1B may comprise an augmentation module 24, which is configured to operate one or more augmentation functions on incoming action sequences to generate augmented action sequences for NN3. The augmentation is performed by an augmentation sub-module 25. In some embodiments, the augmentation sub-module 25 comprises one or more conservative functions and is free of aggressive functions. In some embodiments, sub-module 25 is identical to sub-module 22 in terms of the included augmentation function(s), although the control parameter values may differ. In these cases, sub-module 25 is considered to be configured in correspondence with sub-module 22. It is currently believed to be beneficial for the performance of the trained neural network that the sub-module 25 is configured in correspondence with sub-module 22. After the fine-tuning, the control parameter values [P′] may be output as a definition of the trained network, as indicated by step 613 in FIG. 6, for example for use in the action recognition system 200 in FIG. 2.

However, as also shown in FIG. 6, the fine-tuned neural network may be further processed in a knowledge distillation step 612 to generate a further trained neural network. The further trained network may thereby have improved predictive performance and/or be more compact than the fine-tuned neural network. In the knowledge distillation step 612, the fine-tuned neural network is used as a teacher network to generate and provide activity label data for training a student network. Thus, the knowledge distillation step 612 uses unlabeled action sequences, optionally in combination with labeled action sequences, to train the student network to recognize specific actions. In some embodiments, the student network has the same architecture as the teacher network, resulting in a trained student network with improved action recognition performance. In some embodiments, the student network has a smaller model architecture than the teacher network, for example in terms of the number of channels, resulting in a more compact trained network with minor loss of performance, if any.

FIG. 9 is a block diagram of an example system 1C for knowledge distillation. The system 1C is configured to train a fourth neural network (NN4) 17 based on unlabeled action sequences stored in a database 10. NN4 is thus the above-mentioned student network. The neural network NN3, given by [P′] from the fine-tuning step 602, operates on the unlabeled action sequences to generate representation data in the form of activity label data, which comprises hard labels or soft labels, depending on implementation. An updating module 18 is arranged to receive the activity label data from NN3 and representation data generated by NN4 for the unlabeled action sequences. The updating module 18 is configured, in conventional manner, to update control parameters of NN4 to minimize a difference between the representation data and the activity label data. When the training is completed, the trained NN4 is defined by its control parameter values, [P″], which may be output by step 613 (FIG. 6) for example for use in the action recognition system 200 in FIG. 2. As indicated in FIG. 9, the system 1C may comprise an augmentation module 26, which is configured to operate one or more augmentation functions on incoming action sequences to generate augmented action sequences for use by NN3 and NN4. The augmentation is performed by an augmentation sub-module 27, which may or may not be configured in correspondence with sub-module 25 (FIG. 8).

The structures and methods disclosed herein may be implemented by hardware or a combination of software and hardware. In some embodiments, such hardware comprises one or more software-controlled computer resources. FIG. 10 schematically depicts such a computer resource. The computer resource comprises a processing system 1001, computer memory 1002, and a communication interface 1003 for input and/or output of data. The communication interface 1003 may be configured for wired and/or wireless communication. The processing system 1001 may, for example, include one or more of a CPU (“Central Processing Unit”), a DSP (“Digital Signal Processor”), a microprocessor, a microcontroller, an ASIC (“Application-Specific Integrated Circuit”), a combination of discrete analog and/or digital components, or some other programmable logical device, such as an FPGA (“Field Programmable Gate Array”). A control program 1002A comprising computer instructions is stored in the memory 1002 and executed by the processing system 1001 to perform any of the methods, procedures, operations, functions or steps described in the foregoing. As indicated in FIG. 10, the memory 1002 may also store control data 1002B for use by the processing system 1002. The control program 1002A may be supplied to the computing resource on a computer-readable medium 1100, which may be a tangible (non-transitory) product (for example, magnetic medium, optical disk, read-only memory, flash memory, etc.) or a propagating signal.

In the following, clauses are recited to summarize some aspects and embodiments of the invention as disclosed in the foregoing.

Clause 1. A system for training of a neural network, said system comprising: a first neural network (11), which is configured to operate on first input data (I1) to generate first representation data; a second neural network (12), which is configured to operate on second input data (I2) to generate second representation data; a first updating module (13), which is configured to update parameters of the first neural network (11) to minimize a difference between the first representation data and the second representation data; a second updating module (14), which is configured to update parameters of the second neural network (12) as a function of the parameters of the first neural network (11); and an augmentation module (20), which is configured to retrieve a plurality of corresponding first and second action sequences, each depicting a respective object performing a respective activity, generate the first and second input data (I1, I2) to include augmented versions of the first and second action sequences; wherein the system is configured to operate the first and second neural networks (11, 12) on one or more instances of the first and second input data (I1, I2) generated by the augmentation module (20) and provide at least a subset of the parameters of the first neural network (11) as a parameter definition ([P1]) of a pre-trained neural network, and wherein the augmentation module (20) comprises a first sub-module (21) which is configured to generate a first augmented version (MAS1) based on a respective first action sequence (AS1), and a second sub-module (22) which is configured to generate a second augmented version (MAS2) based on a respective second action sequence (AS2), wherein the second sub-module (22) differs from the first sub-module (21).

Clause 2. The system of clause 1, wherein the augmentation module (20) is configured to include the corresponding first and second augmented versions (MAS1, MAS2) in the first and second input data (I1, I2) such that the first and second networks (11, 12) operate concurrently on the corresponding first and second augmented versions (MAS1, MAS2).

Clause 3. The system of clause 1 or 2, wherein the first sub-module (21) comprises a first set of augmentation functions (F11, . . . , F1m) which are operable on the respective first action sequence (AS1) to generate the first augmented version (MAS1), wherein the second sub-module (22) comprises a second set of augmentation functions (F21, . . . , F2n) which are operable on the respective second action sequence (AS2) to generate the second augmented version (MAS2), wherein the first and second sets of augmentation functions differ by at least one augmentation function.

Clause 4. The system of any preceding clause, wherein the second sub-module (22) is operable to apply more augmentation than the first sub-module (21).

Clause 5. The system of any preceding clause, wherein each of the first and second action sequences comprise a time sequence of object representations (103), and wherein each of the object representations (103) comprises locations of predefined features (104) on the respective object.

Clause 6. The system of clause 5, wherein the second sub-module (22), to generate the second augmented version (MAS2), is operable to randomly select a coherent subset (102′) of the object representations (103) in the respective second action sequence (AS2).

Clause 7. The system of clause 5 or 6, wherein the second sub-module (22), to generate the second augmented version (MAS2) is operable to distort the object representations (103) in the respective second action sequence (AS2) in a selected direction.

Clause 8. The system of any one of clauses 5-7, wherein the second sub-module (22), to generate the second augmented version (MAS2), is operable to hide a subset of the respective object in the object representations (103) in the respective second action sequence (AS2).

Clause 9. The system of clause 8, wherein the subset corresponds to said predefined features (104) on one side of a geometric plane with a predefined arrangement through the respective object.

Clause 10. The system of any one of clauses 5-9, wherein the second sub-module (22), to generate the second augmented version (MAS2), is operable to perform a temporal smoothing of the object representations (103) in the respective second action sequence (AS2).

Clause 11. The system of any one of clauses 5-10, wherein the second sub-module (22), to generate the second augmented version (MAS2), is operable to randomly select an object representation (103A) in the respective second action sequence (AS2) and rearrange the respective second action sequence (AS2) with the selected object representation (103A) as starting point.

Clause 12. The system of any one of clauses 5-11, wherein the second sub-module (22), to generate the second augmented version (MAS2), is operable to flip the respective object in the object representations (103) in the respective second action sequence (AS2) through a mirror plane.

Clause 13. The system of any one of clauses 5-12, wherein the first sub-module (21), to generate the first augmented version (MAS1), is operable to change a time distance between the object representations (103) in the respective first action sequence (AS1).

Clause 14. The system of any preceding clause, wherein the augmentation module (20) is configured to retrieve the first and second action sequences so as to correspond to different viewing angles onto the respective object performing the respective activity.

Clause 15. The system of any preceding clause, which further comprises a training sub-system (1B), which comprises: a third neural network (15), which is configured to operate on third input data (I3) to generate third representation data, the third neural network (15) being initialized by use of the parameter definition ([P1]), and a third updating module (16), which is configured to update parameters of the third network (15) to minimize a difference between the third representation data and activity label data (L3) associated with the third input data (I3), wherein the training sub-system (1B) is configured to, by the third updating module (16), train the third network (15) to recognize one or more activities represented by the activity label data (L3).

Clause 16. The system of clause 15, wherein the training sub-system (1B) comprises a further augmentation module (25) which is configured to retrieve third action sequences of one or more objects performing one or more activities, generate the third input data (I3) to include third augmented versions of the third action sequences, wherein the further augmentation module (20) is configured in correspondence with the first sub-module (21).

Clause 17. The system of clause 15 or 16, which comprises a fourth neural network (17), which is configured to operate on fourth input data (I4) to generate fourth representation data, and a fourth updating module (18), which is configured to update parameters of the fourth network (17) to minimize a difference between the fourth representation data and fifth representation data, wherein the fifth representation data is generated by the third neural network (15), when trained, being operated on the fourth input data (I4).

Clause 18. The system of clause 17, wherein the fourth neural network (17) has a smaller number of channels than the third neural network (15).

Clause 19. A computer-implemented method for use in training of a neural network, said method comprising: retrieving (601) first and second action sequences of an object performing an activity; generating the first and second input data to include first and second augmented versions of the first and second action sequences; operating (605) a first neural network on the first input data to generate first representation data; operating (606) a second neural network on the second input data to generate second representation data; updating (607) parameters of the first neural network to minimize a difference between the first representation data and the second representation data; updating (608) parameters of the second neural network as a function of the parameters of the first neural network; and providing (610), after operating the first and second neural networks on one or more instances of the first and second input data, at least a subset of the parameters of the first neural network as a parameter definition of a pre-trained neural network, wherein said generating the first and second input data comprises operating (602A) a first sub-module on the first action sequence to generate the first augmented version, and operating (602B) a second sub-module, which differs from the first sub-module, on the second action sequence to generate the second augmented version.

Clause 20. A computer-readable medium comprising computer instructions (1002A) which, when executed by a processor (1001), cause the processor (1001) to the perform the method of clause 19.

What is claimed is:

1. A system for training of a neural network, said system comprising: a first neural network, which is configured to operate on first input data to generate first representation data; a second neural network, which is configured to operate on second input data to generate second representation data; a first updating module, which is configured to update parameters of the first neural network to minimize a difference between the first representation data and the second representation data; a second updating module, which is configured to update parameters of the second neural network as a function of the parameters of the first neural network; and an augmentation module, which is configured to retrieve a plurality of corresponding first and second action sequences, each depicting a respective object performing a respective activity, generate the first and second input data to include augmented versions of the first and second action sequences; wherein the system is configured to operate the first and second neural networks on one or more instances of the first and second input data generated by the augmentation module and provide at least a subset of the parameters of the first neural network as a parameter definition of a pre-trained neural network, and wherein the augmentation module comprises a first sub-module which is configured to generate a first augmented version based on a respective first action sequence, and a second sub-module which is configured to generate a second augmented version based on a respective second action sequence, wherein the second sub-module differs from the first sub-module.

2. The system of claim 1, wherein the augmentation module is configured to include the corresponding first and second augmented versions in the first and second input data such that the first and second networks operate concurrently on the corresponding first and second augmented versions.

3. The system of claim 1, wherein the first sub-module comprises a first set of augmentation functions which are operable on the respective first action sequence to generate the first augmented version, wherein the second sub-module comprises a second set of augmentation functions which are operable on the respective second action sequence to generate the second augmented version, wherein the first and second sets of augmentation functions differ by at least one augmentation function.

4. The system of claim 1, wherein the second sub-module is operable to apply more augmentation than the first sub-module.

5. The system of claim 1, wherein each of the first and second action sequences comprise a time sequence of object representations, and wherein each of the object representations comprises locations of predefined features on the respective object.

6. The system of claim 5, wherein the second sub-module, to generate the second augmented version, is operable to randomly select a coherent subset of the object representations in the respective second action sequence.

7. The system of claim 5, wherein the second sub-module, to generate the second augmented version is operable to distort the object representations in the respective second action sequence in a selected direction.

8. The system of claim 5, wherein the second sub-module, to generate the second augmented version, is operable to hide a subset of the respective object in the object representations in the respective second action sequence.

9. The system of claim 8, wherein the subset corresponds to said predefined features on one side of a geometric plane with a predefined arrangement through the respective object.

10. The system of claim 5, wherein the second sub-module, to generate the second augmented version, is operable to perform a temporal smoothing of the object representations in the respective second action sequence.

11. The system of claim 5, wherein the second sub-module, to generate the second augmented version, is operable to randomly select an object representation in the respective second action sequence and rearrange the respective second action sequence with the selected object representation as starting point.

12. The system of claim 5, wherein the second sub-module, to generate the second augmented version, is operable to flip the respective object in the object representations in the respective second action sequence through a mirror plane.

13. The system of claim 5, wherein the first sub-module, to generate the first augmented version, is operable to change a time distance between the object representations in the respective first action sequence.

14. The system of claim 1, wherein the augmentation module is configured to retrieve the first and second action sequences so as to correspond to different viewing angles onto the respective object performing the respective activity.

15. The system of claim 1, which further comprises a training sub-system, which comprises: a third neural network, which is configured to operate on third input data to generate third representation data, the third neural network being initialized by use of the parameter definition, and a third updating module, which is configured to update parameters of the third network to minimize a difference between the third representation data and activity label data associated with the third input data, wherein the training sub-system is configured to, by the third updating module, train the third network to recognize one or more activities represented by the activity label data.

16. The system of claim 15, wherein the training sub-system comprises a further augmentation module which is configured to retrieve third action sequences of one or more objects performing one or more activities, generate the third input data to include third augmented versions of the third action sequences, wherein the further augmentation module is configured in correspondence with the first sub-module.

17. The system of claim 15, which comprises a fourth neural network, which is configured to operate on fourth input data to generate fourth representation data, and a fourth updating module, which is configured to update parameters of the fourth network to minimize a difference between the fourth representation data and fifth representation data, wherein the fifth representation data is generated by the third neural network, when trained, being operated on the fourth input data.

18. The system of clause 17, wherein the fourth neural network has a smaller number of channels than the third neural network.

19. A computer-implemented method for use in training of a neural network, said method comprising: retrieving first and second action sequences of an object performing an activity; generating the first and second input data to include first and second augmented versions of the first and second action sequences; operating a first neural network on the first input data to generate first representation data; operating a second neural network on the second input data to generate second representation data; updating parameters of the first neural network to minimize a difference between the first representation data and the second representation data; updating parameters of the second neural network as a function of the parameters of the first neural network; and providing, after operating the first and second neural networks on one or more instances of the first and second input data, at least a subset of the parameters of the first neural network as a parameter definition of a pre-trained neural network, wherein said generating the first and second input data comprises operating a first sub-module on the first action sequence to generate the first augmented version, and operating a second sub-module, which differs from the first sub-module, on the second action sequence to generate the second augmented version.

20. A non-transitory computer-readable medium comprising computer instructions which, when executed by a processor, cause the processor to the perform the method of claim 19.
